(19) United States
(12) Patent Application Publication
(10) Pub. No.: US 2026/0246983 A1
(43) Pub. Date: Aug. 20, 2026

(54) VIDEO STREAM PROCESSING METHOD AND APPARATUS, STORAGE MEDIUM, AND ELECTRONIC DEVICE

(71) Applicant: BOE Technology Group Co., Ltd., Beijing (CN)

(72) Inventor: Chaofeng DONG, Beijing (CN)

(73) Assignee: BOE Technology Group Co., Ltd., Beijing (CN)

(21) Appl. No.: 18/992,585

(22) PCT Filed: Jul. 25, 2023
(86) PCT No.: PCT/CN2023/109049

§ 371 Date: Jan. 9, 2025

(30) Foreign Application Priority Data
Jul. 26, 2022 (CN) 202210886340.3

(51) Int. Cl. H04N 21/234; H04N 21/2343; H04N 21/238

(52) U.S. Cl. CPC H04N 21/23418; H04N 21/234309; H04N 21/238

(57) ABSTRACT

A video stream processing method includes: receiving a video playback request sent by a first terminal, and acquiring a to-be-played stream identifier, a network bandwidth and a screen resolution of the first terminal by parsing the video playback request; acquiring, in a preset co-source stream dictionary, a source code service handle matching the to-be-played stream identifier, and acquiring, in the source code service handle, a target service handle matching the screen resolution and/or the network bandwidth; and acquiring a target video stream corresponding to the target service handle, and pushing the target video stream to the first terminal.

### CROSS-REFERENCES TO RELATED APPLICATIONS

This disclosure claims priority of Chinese application document with the application number 202210886340.3, the filing date Jul. 26, 2022, and the title of invention: “video stream processing method and apparatus, storage medium, and electronic device”, the entire content of which is incorporated herein by reference in its entirety.

### TECHNICAL FIELD

Embodiments of this disclosure relate to the technical field of audio and video processing, and specifically, to a video stream processing method, a video stream processing apparatus, a computer-readable storage medium, and an electronic device.

### BACKGROUND

In prior art, it is impossible to push a corresponding video stream to a terminal device according to its own bandwidth and resolution.

### SUMMARY

According to an aspect of this disclosure, a video stream processing method is provided and includes:
receiving a video playback request sent by a first terminal, and acquiring a to-be-played stream identifier, a network bandwidth and a screen resolution of the first terminal by parsing the video playback request;
acquiring, in a preset co-source stream dictionary, a source code service handle matching the to-be-played stream identifier, and acquiring, in the source code service handle, a target service handle matching the screen resolution and/or the network bandwidth; and
acquiring a target video stream corresponding to the target service handle, and pushing the target video stream to the first terminal.

In an exemplary embodiment of this disclosure, acquiring the target video stream corresponding to the target service handle includes:
acquiring, if the target service handle matching the screen resolution and/or the network bandwidth is acquired in the source code service handle, the target video stream corresponding to the target service handle; and
acquiring, if the target service handle matching the screen resolution and/or the network bandwidth is not acquired in the source code service handle, a transcoded video stream by transcoding a source video stream corresponding to the to-be-played stream identifier, and using the transcoded video stream as the target video stream.

In an exemplary embodiment of this disclosure, the source code service handle is stored in form of key-value pairs;
a key of the source code service handle is a main stream identifier of a source video stream; and
a value of the source code service handle is an original resolution and/or an original bit rate of the source video stream.

In an exemplary embodiment of this disclosure, a value of the source code service handle further includes one or more transcoding service handles;
a key of the transcoding service handle is a transcoding identifier of the source video stream, and a value of the transcoding service handle is a transcoding resolution and/or a transcoding bit rate of a transcoded video acquired through transcoding.

In an exemplary embodiment of this disclosure, acquiring the transcoded video stream by transcoding the source video stream corresponding to the to-be-played stream identifier includes:
acquiring a source picture group included in the source video stream corresponding to the to-be-played stream identifier, and acquiring a source key frame included in the source picture group;
acquiring an instantaneous decoding refresh (IDR) frame in the source key frame, and acquiring a sequence parameter set and a picture parameter set included in the IDR frame by parsing the IDR frame; and
initializing a preset transcoding function based on the sequence parameter set and the picture parameter set, and acquiring the transcoded video stream by transcoding the source video stream based on the initialized transcoding function.

In an exemplary embodiment of this disclosure, acquiring the transcoded video stream by transcoding the source video stream based on the initialized transcoding function includes:
acquiring encapsulated format data by decapsulating the source video stream based on the initialized transcoding function, and acquiring compressed audio data and compressed video data by decapsulating the encapsulated format data;
acquiring original audio data and original video data by performing audio decoding and video decoding on the compressed audio data and the compressed video data, and acquiring transcoded audio data and transcoded video data by transcoding the original audio data and the original video data; and
acquiring the transcoded video stream by encapsulating the transcoded audio data and the transcoded video data.

In an exemplary embodiment of this disclosure, the video stream processing method further includes:
generating a transcoding identifier corresponding to the transcoded video stream, and generating a to-be-added transcoding service handle of the transcoded video stream based on the transcoding identifier, a transcoding resolution and a transcoding bit rate of the transcoded audio data and the transcoded video data; and
updating the source code service handle of the source video stream using the to-be-added transcoding service handle.

In an exemplary embodiment of this disclosure, a transcoded key frame included in each transcoded picture group of the transcoded video stream with different transcoding resolutions and transcoding bit rates is same as a source keyframe included in the source code picture group.

In an exemplary embodiment of this disclosure, before acquiring the transcoded video stream by transcoding the source video stream corresponding to the to-be-played stream identifier, and pushing the transcoded video stream to the first terminal, the video stream processing method further includes:
reading the transcoded picture group or the source code picture group, and placing the transcoded picture group or the source code picture group into a preset cache channel; and
pushing, based on a placement order of the transcoded picture group or the source code picture group in the cache channel, the transcoded picture group or the source code picture group to the first terminal.

In an exemplary embodiment of this disclosure, reading the transcoded picture group or the source code picture group includes:
acquiring one or more transcoding resolutions, and/or one or more transcoding bit rates, and/or a source code resolution and a source code bit rate included in the source code service handle;
acquiring a first difference calculation result by calculating a difference between the network bandwidth and the source code bit rate and/or the transcoding bit rate, and acquiring a second difference calculation result by calculating a difference between the screen resolution and the source code resolution and/or the transcoding resolution; and
determining the target service handle based on the first difference calculation result and the second difference calculation result, and reading the transcoded picture group or the source code picture group corresponding to a target stream identifier included in the target service handle.

In an exemplary embodiment of this disclosure, the transcoded picture group or the source code picture group includes a current key frame, a first predicted frame obtained by performing prediction on the current key frame, and a second predicted frame obtained by performing prediction on the current key frame and the first predicted frame; and
the video stream processing method further includes:
acquiring the current key frame by performing calculation on the source video stream based on a preset image recognition model, where the image recognition model includes any one or more of a convolutional neural network model, a recurrent neural network model, and a deep neural network model.

In an exemplary embodiment of this disclosure, the video stream processing method further includes:
receiving a source video stream sent by a second terminal, and configuring a main stream identifier for the source video stream;
generating a source code service handle of the source video stream according to an original resolution and an original bit rate of the source video stream and the main stream identifier; and
constructing the preset co-source stream dictionary according to the source code service handle.

In an exemplary embodiment of this disclosure, the video stream processing method further includes:
sending a heartbeat detection message to the first terminal at intervals of a first preset duration, and detecting whether the first terminal sends a heartbeat response message corresponding to the heartbeat detection message within a second preset duration;
obtaining, if the first terminal does not send the heartbeat response message within the preset duration, a to-be-deleted transcoding service handle of the first terminal corresponding to the unsent heartbeat response message; and
determining a source code service handle corresponding to the to-be-deleted transcoding service handle based on a transcoding stream identifier included in the to-be-deleted transcoding service handle, and deleting the to-be-deleted transcoding service handle from the source code service handle.

According to an aspect of this disclosure, a video stream processing apparatus is provided and includes:
a video playback request parsing module, configured to receive a video playback request sent by a first terminal, and acquire a to-be-played stream identifier, a network bandwidth and a screen resolution of the first terminal by parsing the video playback request;
a source code service handle matching module, configured to acquire, in a preset co-source stream dictionary, a source code service handle matching the to-be-played stream identifier, and acquire, in the source code service handle, a target service handle matching the screen resolution and/or the network bandwidth; and
a target video stream pushing module, configured to acquire a target video stream corresponding to the target service handle, and push the target video stream to the first terminal.

According to an aspect of this disclosure, a computer-readable storage medium is provided for storing a computer program thereon, where the computer program is used for, upon being executed by a processor, implementing the video stream processing method according to any one of the forgoing embodiments.

According to an aspect of this disclosure, an electronic device is provided and includes:
a processor; and
a memory, configured to store executable instructions of the processor;
where the processor is configured to, through executing the executable instructions, implement the video stream processing method according to any one of the forgoing embodiments.

It is to be understood that both the foregoing general description and the following detailed description are exemplary and explanatory only and are not restrictive of this disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure. Apparently, the drawings in the following description are only some embodiments of this disclosure, and those skilled in the art can obtain other drawings according to these drawings without creative efforts.

FIG. 1 schematically illustrates a flow chart of a video stream processing method according to an exemplary embodiment of this disclosure.

FIG. 2 schematically shows an exemplary diagram of a specific implementation scenario of a video stream processing method according to an exemplary embodiment of this disclosure.

FIG. 3 schematically shows an exemplary structural diagram of a server according to an exemplary embodiment of this disclosure.

FIG. 4 schematically shows an exemplary diagram of a server-based transcoding scenario according to an exemplary embodiment of this disclosure.

FIG. 5 schematically illustrates a method flow chart of a process for constructing a co-source stream dictionary according to an exemplary embodiment of this disclosure.

FIG. 6 schematically shows an exemplary structural diagram of a co-source stream dictionary according to an exemplary embodiment of this disclosure.

FIG. 7 schematically shows a flow chart of a method for acquiring a transcoded video stream by transcoding a source video stream corresponding to the to-be-played stream identifier according to an exemplary embodiment of this disclosure.

FIG. 8 schematically shows an exemplary structural diagram of a source GOP (Group Of Picture or picture group) according to an exemplary embodiment of this disclosure.

FIG. 9 schematically shows an exemplary diagram of a scenario for transcoding a source video stream according to an exemplary embodiment of this disclosure.

FIG. 10 schematically shows a flow chart of a method for deleting a transcoding service handle according to an exemplary embodiment of this disclosure.

FIG. 11 schematically shows an exemplary diagram of a scenario in which an interface of a transcoding service is called and a transcoding task is issued according to an exemplary embodiment of this disclosure.

FIG. 12 schematically shows an exemplary diagram of a scenario for performing asynchronous operations on transcoding services according to an exemplary embodiment of this disclosure.

FIG. 13 schematically shows a block diagram of a video stream processing apparatus according to an exemplary embodiment of this disclosure.

FIG. 14 schematically illustrates an electronic device for implementing the above video stream processing method according to an exemplary embodiment of this disclosure.

### DETAILED DESCRIPTION

Exemplary embodiments will now be described more fully with reference to the accompanying drawings. Exemplary embodiments may, however, be embodied in various forms and should not be construed as limited to the examples set forth herein. Rather, these embodiments are provided so that this disclosure will be thorough and complete, and will fully convey the concepts of the exemplary embodiments to those skilled in the art. The described features, structures or characteristics may be combined in any suitable manner in one or more embodiments.

Furthermore, the drawings are merely schematic illustrations of this disclosure and are not necessarily drawn to scale. The same reference numerals in the drawings represent the same or similar parts, and thus their repeated description will be omitted. Some of the block diagrams shown in the drawings are functional entities and do not necessarily correspond to physically or logically separate entities. These functional entities may be implemented in software form, or implemented in one or more hardware modules or integrated circuits, or implemented in different networks and/or processor devices and/or microcontroller devices.

In the development of streaming media, requirements are often encountered for different resolutions or bit rates for the same video stream. For example, when a 1280P real-time stream is pushed up through RTSP (Real Time Streaming Protocol) or RTMP (Real Time Messaging Protocol), but in fact the network rate at the player end is low or unstable, it may be necessary to convert the resolution or bit rate of the real-time stream, so as to ensure that users can play without lag through streaming.

In some technical solutions, the live streams pushed by RTSP and RTMP are commonly video and audio streams with specified resolution or bit rate. However, it is often encountered that the pushing link network is unstable. In practical applications, in order to ensure the user's good experience and ensure that the video does not stutter or is played through a web page or a designated terminal, additional requirements (e.g., resolution or bit rate) may be proposed for the stream. Nevertheless, in view of the real-time nature of live streaming, in order to reduce the user's delay experience as much as possible, a typical solution is to push another stream with low bit rate or low resolution from the same video source to the media server (e.g., a camera has a main stream and a secondary stream). However, since the camera needs to encode the main and secondary streams at the same time, which puts a heavy burden on the camera, there will be a problem of delayed streaming, causing delays between the anchor client and the live viewing client(s). In addition, when the main and secondary streams need to be pushed at the same time, a heavy occupation of network bandwidth may occur, and there may be demands that cannot be met except the main and secondary streams.

In view of above, some embodiments first provide a video stream processing method, which can be run on a server, a server cluster, a cloud server, or the like. Alternatively, those skilled in the art can also implement the disclosed method on other platforms according to actual needs, which are not particularly limited in the embodiments. Referring to FIG. 1, the video stream processing method may include the following steps.

In step S110, a video playback request sent by a first terminal is received, and a to-be-played stream identifier, a network bandwidth and a screen resolution of the first terminal are acquired by parsing the video playback request.

In step S120, a source code service handle matching the to-be-played stream identifier is acquired in a preset co-source stream dictionary, and a target service handle matching the screen resolution and/or the network bandwidth is acquired in the source code service handle.

In step S130, a target video stream corresponding to the target service handle is acquired and pushed to the first terminal.

In the above video stream processing method, on the one hand, by receiving the video playback request sent by the first terminal and parsing the video playback request, the to-be-played stream identifier, the network bandwidth and the screen resolution of the first terminal are acquired; then the source code service handle matching the to-be-played stream identifier is acquired in the preset co-source stream dictionary, and the target service handle matching the screen resolution and/or the network bandwidth is acquired in the source code service handle; finally, the target video stream corresponding to the target service handle is acquired and pushed to the first terminal; thereby causing the target video stream to match the network bandwidth and the screen resolution of the first terminal, and solving the problem in related art that the pushed video stream cannot match the bandwidth and resolution of the terminal device. On the other hand, because the target video stream is matched according to the screen resolution and network bandwidth of the first terminal, delayed display due to bandwidth mismatch problems or lagging problems caused by mismatched screen resolutions can be avoided, thereby improving the user's viewing experience.

The video stream processing method according to some exemplary embodiments of this disclosure will be explained and described in detail with reference to the accompanying drawings as follows.

First, the purpose of the invention according to some exemplary embodiments of this disclosure is explained and described. Specifically, based on the video stream processing method according to some exemplary embodiments of this disclosure, the pushed source video stream is encoded and decoded again to generate a new stream with specified resolution and bit rate without affecting the source video stream. In this way, the resolution and bit rate can be dynamically adjusted to more flexibly meet the actual live streaming requirements (e.g., different bit rates and resolutions) at the user side. There is no need to push the same video source to the media service multiple times, thereby achieving the purpose of meeting the actual live streaming needs of the user side while reducing the bandwidth occupancy rate and the burden on the camera. In a specific application process, some exemplary embodiments of this disclosure adopt the basic codec library of FFMPEG to re-encode the source video stream. At the same time, in order to avoid large delays, the system may cache a certain number of frames (GOP length) for data initialization operation upon switching encodings. Also, based on the video stream processing method according to some exemplary embodiments of this disclosure, a mapping between the main stream and the converted stream can be established, thereby facilitating quick retrieval when the player pulls the stream.

Next, specific implementation scenarios of the video stream processing method according to some exemplary embodiments of this disclosure are explained and described.

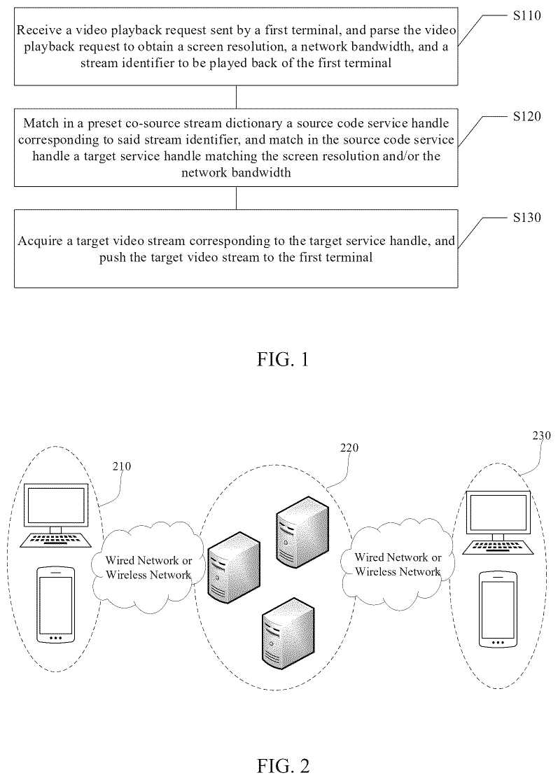

Specifically, the video stream processing method according to some exemplary embodiments of this disclosure can be used for high-definition live broadcast where low-resolution and low-bit-rate video source is required upon performing synchronous playback through the Web, video wall, mobile phone, specific low-end terminals, and the like. Further, as shown in FIG. 2, the application scenario involved in the video stream processing method according to some exemplary embodiments of this disclosure may include a first terminal 210, a server 220 and a second terminal 230. The second terminal may be a terminal that includes a camera component and is configured to capture a source video stream. The first terminal may be a terminal for watching live video and may be configured to play the video stream. The server may be configured to implement the video stream processing method according to some exemplary embodiments of this disclosure. Moreover, the first terminal and the second terminal may be connected to the server through a wired network or a wireless network.

Specifically, the first terminal involved in the exemplary embodiments may be a set-top box, a mobile phone, a tablet (Pad), a computer with wireless transceiver functions, a VR (Virtual Reality) terminal, an AR (Augmented Reality) terminal, a wireless terminal in Industrial Control, a wireless terminal in Self Driving, a wireless terminal in remote medical, a wireless terminal in smart grid, a wireless terminal in transportation safety, a wireless terminal in smart City, a wireless termina in smart Home, and the like, which are not limited in these embodiments.

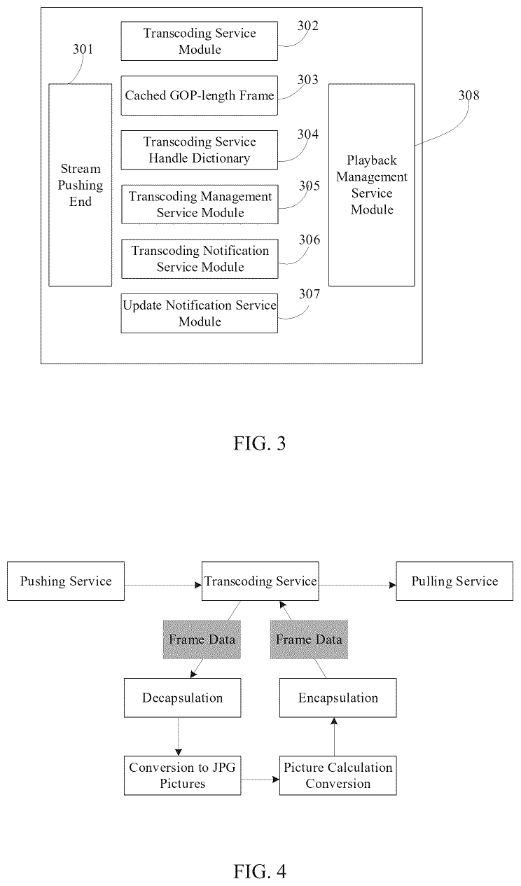

Further, as shown in FIG. 3, the server may include a stream pushing end 301, a transcoding service module 302, a cached GOP-length frame 303, a transcoding service handle dictionary 304, a transcoding management service module 305, a transcoding notification service module 306, a co-source stream dictionary 307, an update notification service module 308 and a play back management service module 309.

The stream pushing end 301 refers to the access service of RTMP/RTSP streams. The stream pushing end is responsible for receiving video and audio streams. The transcoding service module 302 provides independent transcoding capabilities and can be invoked as a module or activated as an independent service. The parameters and structure included in the transcoding service module 302 may be as follows.

The cached GOP-length frame refers to caching of original frame data of a certain video stream. The transcoding service handle dictionary refers to, in response to a transcoding service (parameters including stream ID, transcoding resolution, bit rate and the like may need to configured) requested by a service side, the system will eventually generate a transcoding service handle, and a dictionary may be formed by the transcoded stream IDs (so as to facilitate management) and corresponding handles. The transcoding management service is responsible for receiving requests from the service side, creating and closing transcoding handles, and the like. The transcoding notification service module refers to that each request from the service side should correspond to a notification service, and the object of the notification service is the streaming service. The co-source stream dictionary includes Keys as the main stream IDs (the main stream is also the source video stream, or can be called the untranscoded stream); and Values as a dictionary (Key is the transcoding stream ID, Value is an object (the object includes at least resolution and bit rate)), where the dictionary is mainly used for customer management services. The update notification service module is configured to receive a notification from the transcoding service and update the co-source stream dictionary accordingly. The playback management service waits to receive a playback request from a player end, and request a corresponding stream from the co-source stream dictionary for push based on the playback parameters (bit rate or resolution). For specific examples of the transcoding service scenario, FIG. 4 may be referred to.

It is to be noted that the video stream processing method according to some exemplary embodiments of this disclosure is ultimately to achieve the goal of: performing conversion on a pushed source video stream according to actual needs of user (i.e., the first terminal), thereby meeting the dynamically changing network environment of the play back end, satisfying designated terminals and realizing seamless playback. Moreover, by calling the underlying transcoding library of the FFMPEG tool, the bit rate and resolution conversion of RTSP or RTMP is realized through service-level adjustments, thereby meeting the service needs and good experience at the streaming side.

Further, the source video stream according to some exemplary embodiments of this disclosure is to be explained and described. Specifically, the source video stream according to some exemplary embodiments of this disclosure may be an RTSP stream or an RTMP stream, or other streams, which is not particularly limited in this example. Specifically, RTSP is an application-layer protocol in the TCP/IP (Transmission Control Protocol/Internet Protocol) system. There may be variety of packaging formats in the RTSP stream. For example, it may be a TS (Transport Stream) format, or an ES (Elementary Stream) format, or a raw bitstream format.

In an exemplary embodiment, the raw bitstream can be encoded into an ES stream, and the ES stream can be packaged into a TS stream. The raw bitstream is an unencoded data stream that contains both audio data and video data. The ES stream is a data stream that contains only one kind of content and consists of several ES packets, such as an ES stream that only contains video data or an ES stream that only contains audio data. When encoding the raw bitstream, video data and audio data can be divided first, and the raw bitstream is to be encoded into an ES stream containing only video data and an ES stream containing only audio data. The ES packets in the ES stream can be further encapsulated into a TS packet(s) to form a TS stream, and the TS packet(s) can be independently encoded or decoded. In an exemplary embodiment, the above-mentioned source video stream also includes a protocol header. In the process of transcoding the source video stream, the protocol is to be decoded (or called de-protocol) first. For example, if the source video stream is an RTSP stream, then the source video stream accordingly contains an RTSP header; if the source video stream is an RTMP stream, then the source video stream accordingly contains an RTMP header.

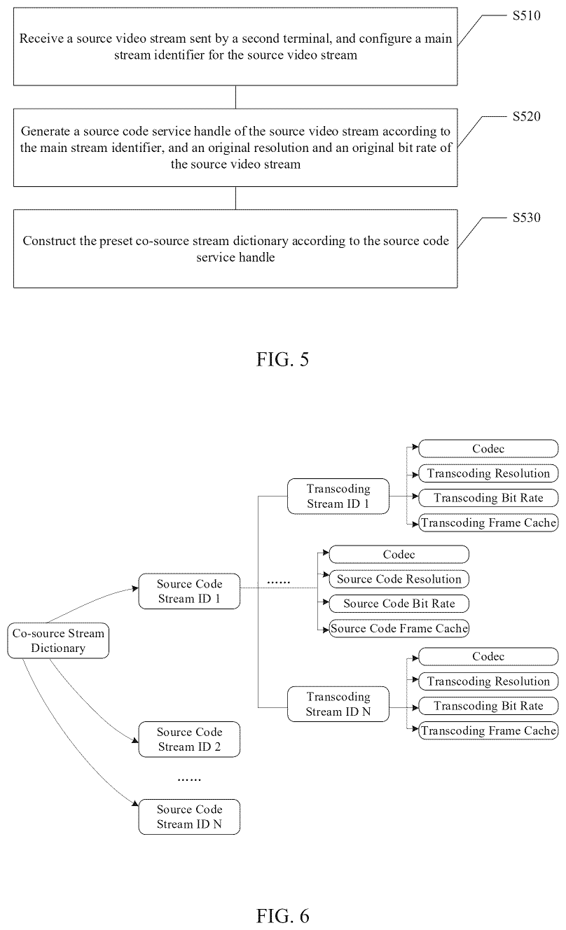

The construction process of the co-source stream dictionary involved in some exemplary embodiments of this disclosure will be explained and described below with reference to FIG. 5. Specifically, as shown in FIG. 5, the following steps may be included.

In step S510, a source video stream sent by a second terminal is received, and a main stream identifier is configured for the source video stream.

In step S520, a source code service handle of the source video stream is generated according to the main stream identifier, and an original resolution and an original bit rate of the source video stream.

In step S530, the preset co-source stream dictionary is constructed according to the source code service handle.

In the following, steps S510 to S530 will be explained and described. Specifically, first, the source video stream sent by the second terminal can be received through a stream pushing end in the service. In some embodiments, in the high-definition live broadcast scenario, the second terminal can be a terminal including a camera component. Accordingly, the source video stream is captured under the high-definition live broadcast scenario through the camera component and, then, is transmitted to the terminal and subsequently transmitted to the stream pushing end through the terminal. Further, in this live broadcast scenario, the second terminal can be a terminal where an anchor user is located. When the stream pushing end receives the source video stream, the main stream identifier can be configured for the source video stream, and then the source code service handle of the source video stream can be generated based on the main stream identifier, as well as the original resolution and the original bit rate of the source video stream. Then the preset co-source stream dictionary can be constructed based on the source code service handle. An exemplary diagram of the obtained co-source stream dictionary is shown in FIG. 6.

It is to be noted that the main stream identifier mentioned here, in the live broadcast scenario, may depend on the user identity of the anchor user or the live broadcast room identity where the anchor user is located, which is not particularly limited in this example.

It is to be further noted that the source code service handle may be stored in the form of key-value pairs; where the keys of the source code service handle include the main stream identifiers of the source video stream and the values of the source code service handle include the original resolution and/or original bit rate of the source video stream. The values of the source code service handle may further include one or more transcoding service handles; where the keys of a transcoding service handle include transcoding identifiers of the source video stream, and the values of the transcoding service handle include the transcoding resolution and/or transcoding bit rate of the transcoded video. In other words, in the obtained preset co-source stream dictionary, the main stream identifier (main stream ID) of the source video stream can be used as the unique key to facilitate quick retrieval. The value corresponding to this key may include the original resolution and original bit rate of the source video stream, and may further include the transcoding identifier of the transcoded video stream corresponding to the source video stream, as well as the transcoding resolution and the transcoding bit rate of the transcoded video stream.

Hereinafter, the video stream processing method shown in FIG. 1 will be explained and described in detail with reference to FIG. 2 and FIG. 6, specifically as follows.

In step S110, a video playback request sent by the first terminal is received, and the video playback request is parsed to obtain a network bandwidth, a to-be-played stream identifier, and a screen resolution of the first terminal.

In some exemplary embodiments, the video playback request sent by the first terminal is received first. Herein, taking the first terminal being a set-top box as an example, the video playback request sent by the set-top box may be received, and the video playback request may include the network bandwidth, the to-be-played stream identifier as requested, and the screen resolution of a video display device (e.g., a television, a projector, or the like) accessing the set-top box. The to-be-played stream identifier mentioned here is the same as the main stream identifier of the source video stream.

Subsequently, when the transcoding management service module on the server side receives the video playback request, it can parse the video playback request and obtain the corresponding screen resolution, network bandwidth, and to-be-played stream identifier as requested.

In step S120, the source code service handle corresponding to the to-be-played stream identifier is retrieved by matching in the preset co-source stream dictionary, and a target service handle matching the screen resolution and/or network bandwidth is retrieved in the source code service handle.

In some exemplary embodiments, after acquiring the screen resolution, network bandwidth, and the requested to-be-played stream identifier, a source code service handle corresponding to the to-be-played stream identifier can be first matched in the preset co-source stream dictionary. In the process of matching the source code service handle, the main stream identifier included in the source code service handle may be retrieved based on the to-be-played stream identifier. After the corresponding main stream identifier is matched, the source code service handle associated with the main stream identifier is the source code service handle corresponding to the to-be-played stream identifier. Then, after acquiring the source code service handle corresponding to the to-be-played stream identifier, the target service handle corresponding to the screen resolution and network bandwidth can be retrieved by matching the original resolution, original bit rate, transcoding resolution and transcoding bit rate.

It is to be noted that in a specific application process, by first querying the corresponding source code service handle, and then matching the target service handle corresponding to the screen resolution and network bandwidth in the source code service handle, the matching efficiency can be improved. Moreover, since the source code service handle includes all transcoding service handles corresponding to the main stream identifier, the accuracy of the matching results can be further improved. In addition, in some application scenarios, matching of the screen resolution or the network bandwidth can be performed independently, which is not particularly limited in this example.

In step S130, a target video stream corresponding to the target service handle is acquired and, then, pushed to the first terminal.

In this exemplary embodiment, first, the target video stream corresponding to the target service handle is obtained. Specifically, it can be implemented in the following manner. If the target service handle matching the screen resolution and/or network bandwidth is matched in the source code service handle, then the target video stream corresponding to the target service handle is acquired. If the target service handle matching the screen resolution and/or network bandwidth cannot matched in the source code service handle, the source video stream corresponding to the to-be-played stream identifier is transcoded to obtain a transcoded video stream, which is to be used as the target video stream.

In other words, during the specific application process, if there is a target service handle that matches the screen resolution and network bandwidth, the target video stream corresponding to the target service handle will be pushed to the first terminal; if there is no target service handle that meets both the screen resolution and the network bandwidth, it is to be determined whether there is a target service handle that meets the network bandwidth; if there is no target service handle that meets the network bandwidth, it is to be determined whether there is a target service handle that meets the screen resolution; if there is no target service handle that meets any one condition, the source video stream can be transcoded. In some exemplary embodiments, if there is a target service handle that meets the network bandwidth but does not meet the screen resolution, the source video stream can be transcoded with respect to the screen resolution or can be directly pushed, which is not particularly limited in this example. In some exemplary embodiments, if there is a target service handle that meets the screen resolution but does not meet the network bandwidth, the source video stream can be transcoded with respect to the network bandwidth or can be directly pushed, which is not particularly limited in this example.

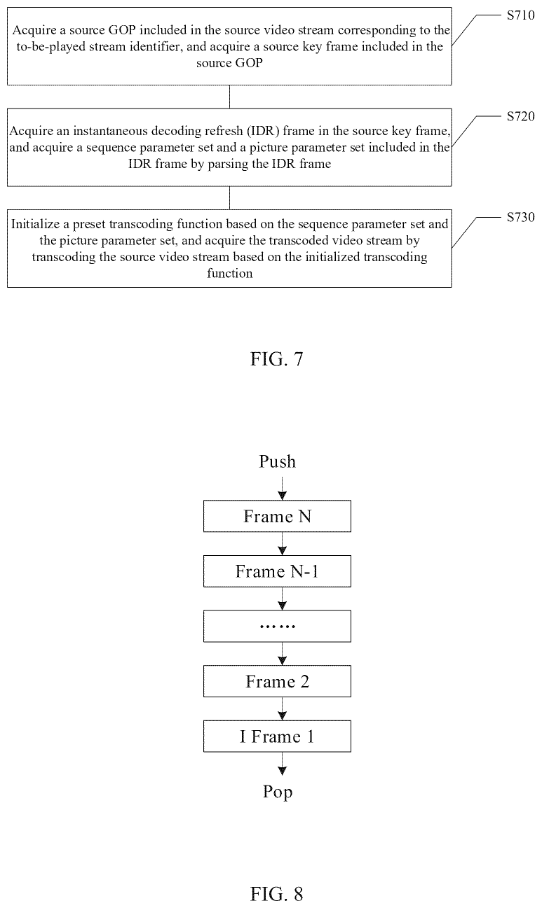

FIG. 7 schematically shows a flow chart of a method for transcoding a source video stream corresponding to the to-be-played stream identifier to obtain a transcoded video stream according to an exemplary embodiment of this disclosure. Specifically, as shown in FIG. 7, the following steps may be included.

In step S710, a source GOP included in the source video stream corresponding to the to-be-played stream identifier is acquired, and a source key frame included in the source GOP is acquired.

In step S720, an instantaneous decoding refresh (IDR) frame in the source key frame is acquired, and a sequence parameter set and a picture parameter set included in the IDR frame is acquired by parsing the IDR frame.

In step S730, a preset transcoding function is initialized based on the sequence parameter set and the picture parameter set, and the transcoded video stream is acquired by transcoding the source video stream based on the initialized transcoding function.

In an exemplary embodiment, acquiring the transcoded video stream by transcoding the source video stream based on the initialized transcoding function can be achieved in the following manner. First, the source video stream is de-protocoled based on the initialized transcoding function to obtain encapsulated format data, and the encapsulated format data is decapsulated to obtain compressed audio data and compressed video data. Secondly, audio decoding and video decoding are performed on the compressed audio data and compressed video data to obtain original audio data and original video data, and the original audio data and original video data is transcoded to obtain transcoded audio data and transcoded video data. Finally, packet processing is performed on the transcoded audio data and transcoded video data to obtain the transcoded video stream.

In the following, steps S710 to S730 will be explained and described. Specifically, in the specific process of bit rate conversion, the transcoding service performs necessary initialization operations after receiving the stream. The specific initialization process may include initialization of caching a dictionary of transcoding handles and caching latest frame data of the GOP length, which is typically the interval length between two key frames. After the initialization is completed, the source GOP can be obtained. In some embodiments, as shown in FIG. 8, a GOP is a group of continuous pictures. The GOP structure generally has two numbers, one of which is the length of GOP (i.e., the number of B frames and P frames between two I frames), and the other number is the separation distance between the I frame and P frame (i.e., the number of B frames). The decoding of I frame within a GOP does not depend on any other frames, while the decoding of P frame depends on the previous I frame or P frame, and the decoding of B frame depends on the previous I frame or P frame and the closest P frame after the B frame. Moreover, the I frame in the GOP can be divided into ordinary I frame and IDR Frame, IDR frame is the first I frame of the GOP. This division is for the purpose of edge sealing control encoding and decoding process. In addition, the IDR frame is an I frame, but the I frame is not necessarily an IDR frame. Because the IDR frame comes with information such as SPS (Sequence Parameter Set) and PPS (Picture Parameter Set), what the decoder needs to do upon receiving the IDR frame is to update all PPS and SPS parameters. In other words, the function of the IDR frame is to allow the decoder to timely refresh relevant data information to avoid major decoding errors. Further, the introduction of the IDR frame mechanism is for decoding resynchronization. When the decoder decodes the IDR frame, it will clear the reference frame queue immediately, output or discard all the decoded data, re-search the parameter set, and start a new sequence. In this way, if there is an error in the previous sequence, an opportunity can be obtained for resynchronization, as frames following the IDR frame will never be decoded using data from before the IDR frame.

In view of the forgoing description, after acquiring the source GOP, the source IDR frame in the source GOP can be obtained, then the preset transcoding function can be initialized according to the sequence parameter set and picture parameter set included in the source IDR frame, thereby performing transcoding based on the initialized transcoding function to obtain the transcoded video stream. In some embodiments, the mentioned transcoding function may be an FFMpeg function. It is to be noted that, before initializing the preset transcoding function through the sequence parameter set and picture parameter set, it may also be necessary to determine whether the sequence parameter set and picture parameter set are complete. If they are incomplete, it may need to receive complete sequence parameter set and picture parameter set by parsing other received frames, and complete the incomplete sequence parameter set and picture parameter set through the complete sequence parameter set and picture parameter set before performing the corresponding transcoding.

Furthermore, in a specific transcoding process of the source video stream through FFMpeg, the de-protocol, de-encapsulation, decoding and data synchronization process involved may be as follows.

First, the de-protocol processing may parse the data of the streaming media protocol into corresponding data of a standard encapsulation format. Specifically, when the stream pushing end receives the source video stream, various streaming media protocols (e.g., RTMP, RTSP, or the like) may be adopted. While transmitting video and audio data through these protocols, some signaling data is also transmitted. These signaling data may include control of playback (play, pause, stop), description of network status, or the like. Herein, during the de-protocol processing, the signaling data will be removed and only the video and audio data will be retained. For example, data transmitted using the RTMP protocol will be output in FLV format after the de-protocol processing,.

Second, the decapsulation processing may separate the input encapsulation format data into audio stream compression encoding data and video stream compression encoding data. There are many types of encapsulation formats, such as MP4, MKV, RMVB, TS, FLV, AVI, and the like, whose function is to put compressed and encoded video data and audio data together in a certain format. For example, after decapsulating data in FLV format, an H.264-encoded video stream and an AAC-encoded audio stream are output.

Further, the decoding process may decode the video/audio compression coded data into original uncompressed video/audio data. In some embodiments, the audio compression coding standards include AAC, MP3, AC-3, and the like, and the video compression coding standards include H.264, MPEG2, VC-1, and the like. Through decoding, the compressed and encoded video data is output into uncompressed color data, such as YUV420P, RGB, and the like; and the compressed and encoded audio data is output into uncompressed audio sampling data, such as PCM data.

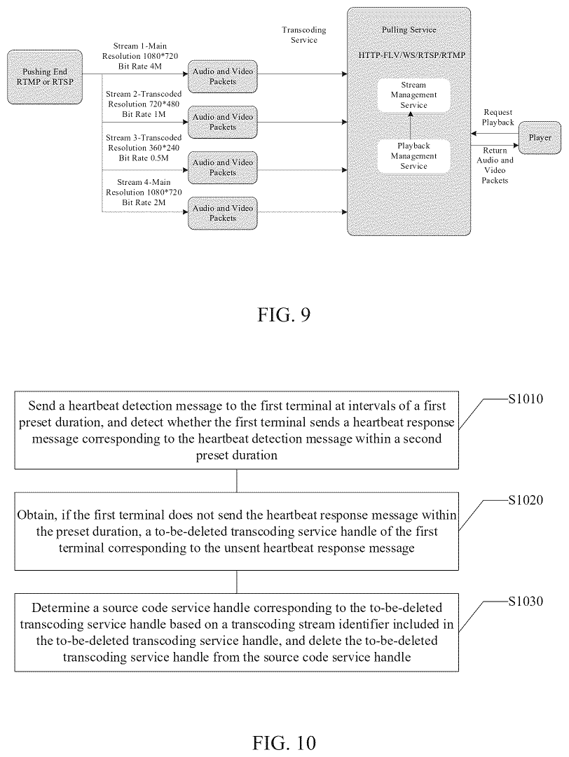

Finally, the encapsulation processing may perform synchronization on the decoded video and audio data based on the parameter information obtained during the decapsulation processing, and send the video and audio data to the graphics card and sound card of system for playback. In some embodiments, a specific exemplary diagram of conversion scenario may be referred to as shown in FIG. 9.

In an exemplary embodiment, after the transcoded video stream is obtained, the video stream processing method may further include: generating a transcoding identifier corresponding to the transcoded video stream, and generating a to-be-added transcoding service handle of the transcoded video stream based on the transcoding identifier, a transcoding resolution and a transcoding bit rate of the transcoded audio data and the transcoded video data; and updating the source code service handle of the source video stream using the to-be-added transcoding service handle. In some embodiments, a transcoded keyframe included in each transcoded GOP of the transcoded video stream with different transcoding resolutions and transcoding bit rates is same as a source keyframe included in the source GOP.

Specifically, the transcoding identifier mentioned here and the main stream identifier mentioned above may be set in association or independently, as long as the key-value relationship between the transcoding identifier and the main stream identifier is ensured. The transcoding service handle mentioned here may exist in the form of key-value or in other forms, which is not particularly limited in this example. Herein, when referring to that the transcoded keyframe included in each transcoded GOP of the transcoded video stream with different transcoding resolutions and transcoding bit rates is the same as the source keyframe included in the source GOP, it is for the purpose that the live broadcast images of the same live broadcast room received by the first terminal with different network bandwidths and screen resolutions are the same, thereby achieving data consistency. In this way, the user's viewing experience can be further improved.

In an exemplary embodiment, the video stream processing method further includes: reading the transcoded GOP or the source code GOP, and placing the transcoded GOP or the source code GOP into a preset cache channel; and pushing, based on a placement order of the transcoded GOP or the source code GOP in the cache channel, the transcoded GOP or the source code GOP to the first terminal. In some embodiments, frames are cached as a cache channel, and the playback point needs to consume frame data in order from this channel, and synchronously send the frame data of the channel to all playback ends that access the stream (so as to ensure the consistency of data at the playback ends). In this way, the delay when the first terminal requests to play the video can be reduced, thereby improving the user's viewing experience.

In an exemplary embodiment, reading the transcoded GOP or the source code GOP can be implemented in the following manner. First, one or more transcoding resolutions, and/or one or more transcoding bit rates, and/or a source code resolution and a source code bit rate included in the source code service handle are acquired. Second, a first difference calculation result is acquired by calculating a difference between the network bandwidth and the source code bit rate and/or the transcoding bit rate, and a second difference calculation result is acquired by calculating a difference between the screen resolution and the source code resolution and/or the transcoding resolution. Then, the target service handle is determined based on the first difference calculation result and the second difference calculation result, and the transcoded GOP or the source code GOP corresponding to a target stream identifier included in the target service handle is read. In other words, in the specific application process, in order to further reduce the delay without affecting the display of the video stream by the first terminal, if the target service handle corresponding to the screen resolution and network bandwidth is not matched, a target service handle with similar screen resolution and/or network bandwidth can be selected, and the GOP corresponding to this target service handle is pushed to the first terminal. Then, after the transcoding is completed, a target video stream corresponding to the screen resolution and network bandwidth of the terminal is pushed to the first terminal. In this way, the seamless transition of the video streams can be achieved, thereby improving the user's viewing experience.

In an exemplary embodiment, the above-mentioned transcoded GOP or source code GOP includes a current key frame (i.e., I frame), a first predicted frame (P frame) obtained by performing prediction on the current key frame, and a second predicted frame (B frame) obtained by performing prediction on the current key frame and the first predicted frame. In some embodiments, the video stream processing method further includes: acquiring the current key frame by performing calculation on the source video stream based on a preset image recognition model, where the image recognition model includes any one or more of a convolutional neural network model, a recurrent neural network model, and a deep neural network model. It is to be noted that in the actual application process, in a specific confirmation process of the current key frame (or it can also be considered as any key frame), it can not only be extracted through the models listed above, but also other models, which is not particularly limited in this example. The forgoing models may be embedded in the server through chips, or may be remotely called through corresponding interfaces, which is not particularly limited in this example.

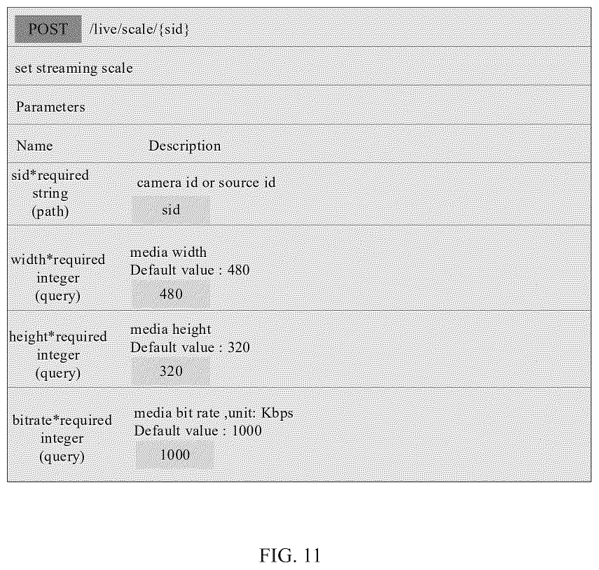

FIG. 10 schematically illustrates a method flow for deleting a transcoding service handle according to an exemplary embodiment of this disclosure. Specifically, as shown in FIG. 10, the following steps may be included.

In step S1010, a heartbeat detection message is sent to the first terminal at intervals of a first preset duration, and it is detected whether the first terminal sends a heartbeat response message corresponding to the heartbeat detection message within a second preset duration.

In step S1020, if the first terminal does not send the heartbeat response message within the preset duration, a to-be-deleted transcoding service handle of the first terminal corresponding to the unsent heartbeat response message is obtained.

In step S1030, a source code service handle corresponding to the to-be-deleted transcoding service handle is determined based on a transcoding stream identifier included in the to-be-deleted transcoding service handle, and the to-be-deleted transcoding service handle is deleted from the source code service handle.

In the following, steps S1010 to S1030 will be explained and described. Specifically, in order to avoid the problem of heavy burden on the server due to too many idle transcoding service handles, the transcoding service handles can be deleted on a regular basis. It is to be noted that during a specific deletion process, a transcoding stream ID to be deleted can be retrieved from the transcoding handle dictionary; and if it exists, the handle will be deleted and closed. Moreover, due to the new stream generated by transcoding (transcoding stream) is based on the source video stream, and there is only one source video stream, so the data itself is highly synchronized.

The video stream processing method according to some exemplary embodiments of this disclosure will be further explained and described in conjunction with specific application scenarios as follows. Specifically, taking a traffic all-media platform in a certain place as an example, the specific implementation process in this traffic all-media platform may be as follows.

First, a pushing service, a transcoding service, and a pulling service are built, and a real-time streaming service is formed through the pushing service, transcoding service, and pulling service. In some embodiments, the pushing service, transcoding service, and pulling service may be started on a same physical machine in the form of Doker. Moreover, before starting the physical machine, the log is to be checked to ensure that the started service has no abnormal alarm information.

Then, the second terminal pushes a video and audio stream 1 (source video stream) with 1920P resolution and 8M bit rate to the pushing service. The streaming media service runs normally, and at the same time, a user at the pulling end can use the player (first terminal) to play this channel of stream I normally.

Further, on the service side (an upper-layer service integrated in the streaming media service), an interface of the transcoding service is called and a transcoding task is issued (FIG. 11 may be referred to for details). In some embodiments, the transcoding task mainly includes the main stream ID, the length and width, and the bit rate. After the task is successfully delivered, a transcoding handle may be created in the transcoding service. This handle is responsible for copying a main stream frame, pushing the frame to the FFMPEG transcoding interface, and then generating a new frame data for output. Subsequently, the transcoded stream is pushed as streaming data to the pulling end according to the main stream rules.

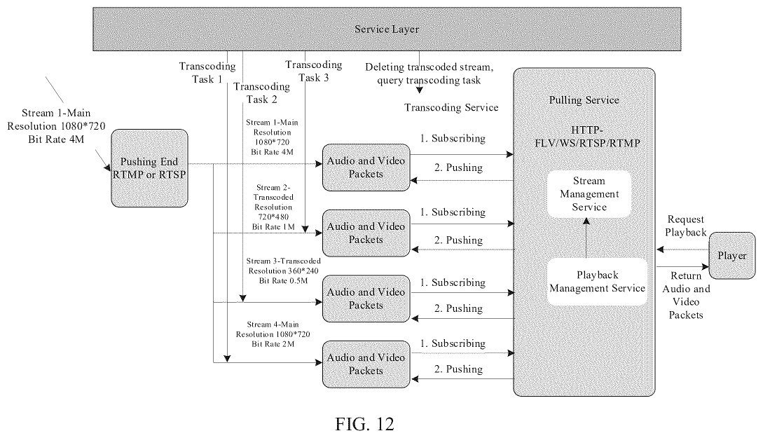

Furthermore, the transcoding task may be an asynchronous operation, and multiple issuances do not affect each other. In addition, the service side can also turn off unnecessary transcoding services (the sid here is the new stream ID after transcoding) based on actual usage. FIG. 12 may be referred to for details.

In a specific application scenario, the traffic all-media platform requires that stream 1 (source video stream) can be viewed in real time on the terminals such as Web and IPAD. Accordingly, a transcoding task (480*320, 1M) may be issued, and a new stream 2 (transcoded video stream) is generated. In view of this, a transcoding service notification can be issued. Moreover, after the transcoding task is completed, a notification may be issued to the pulling service. The purpose of this notification is to inform the pulling end that a new stream is generated, and a pulling operation is needed. After necessary initialization, the transcoding service is accessed to pull the new stream; then, the notification of new stream 2 is sent to the pulling end, and the pulling end can successfully pull real-time frame data of the stream 2 from the transcoding service. Subsequently, both the main stream and transcoded stream can be queried and played on the pulling end.

It is to be noted that the source video stream and transcoded video stream mentioned above are independent streams, which can be independently played without affecting each other. The service side can view existing streams the relevant interfaces. In addition, the service side can select an ID of pulled stream from the pulling end according to the terminal type. Regarding stream selection when the network jitters, and the consistency of streaming at multiple terminals, in order to save bandwidth on the playback end, the service side will create multiple transcoding streams (the resolution and bit rate are lower than the source video stream). The playback end is to bring parameters (requirements on parameters such as resolution or bit rate, which may conditionally change dynamically) according to its own network status, and then request real-time playback at the pulling end. Further, since there is only one channel for each type of transcoded stream and there is data cache at the transcoding service to eliminate inconsistencies, when the player pulls streams, the frames can be uniformly fetched from the frame cache at the pulling end, thereby eliminating the data consistency problem. Alternatively, the pulling end can subscribe to stream 2 and cache a certain number of frames, and the playback management service fetches frames from the cache and throws them to the player. However, this method may still have a delay in sending packets to the player, so a concurrent packet sending mechanism can be considered. In some embodiments, the concurrent packet sending mechanism can be implemented by preparing a thread pool in advance, that is, each thread is responsible for a certain number of playback ends, so as to reduce latency.

In view of above, the video stream processing method according to some exemplary embodiments has been described. Based on the foregoing description, it can be known that the video stream processing method according to some exemplary embodiments of this disclosure has at least the following advantages. On the one hand, multiple new streams with different resolutions and bit rates can be converted from one main stream. Moreover, streams from the same source are managed, and frame data of a specified stream can be quickly retrieved based on the play back parameters, with a time complexity of O(1). On the other hand, the cache of the GOP length realizes synchronization of transcoding service data, thereby achieving seamless transition. In addition, when the system resources are sufficient, unlimited conversion is possible. Further, the RTSP or RTMP protocol can also be implemented to switch streams of different bit rates according to the user's network status, and realize dynamic adjustment of resolution and bit rate for the user, so that it can be used in different scenarios. In specific applications, a certain stream pushed by RTMP or RTSP can also be transcoded to form multiple streams with different resolutions or bit rates, and the streams can be pushed to the player side after being seamlessly transitioned thereby improving the user's viewing experience.

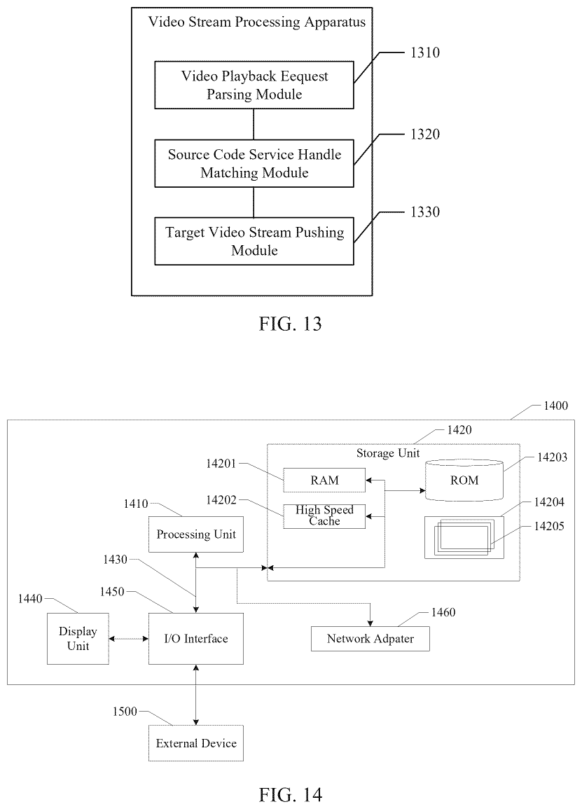

Exemplary embodiments of this disclosure further provide a video stream processing apparatus. Specifically, referring to FIG. 13, the video stream processing apparatus may include a video playback request parsing module 1310, a source code service handle matching module 1320, and a target video stream pushing module 1330.

The video playback request parsing module 1310 may be configured to receive a video playback request sent by a first terminal, and acquire a to-be-played stream identifier, a network bandwidth and a screen resolution of the first terminal by parsing the video playback request.

The source code service handle matching module 1320 may be configured to acquire, in a preset co-source stream dictionary, a source code service handle matching the to-be-played stream identifier, and acquire, in the source code service handle, a target service handle matching the screen resolution and/or the network bandwidth.

The target video stream pushing module 1330 may be configured to acquire a target video stream corresponding to the target service handle, and push the target video stream to the first terminal.

Based on the above video stream processing apparatus, on the one hand, by receiving the video playback request sent by the first terminal and parsing the video playback request, the to-be-played stream identifier, the network bandwidth and the screen resolution of the first terminal are acquired; then the source code service handle matching the to-be-played stream identifier is acquired in the preset co-source stream dictionary, and the target service handle matching the screen resolution and/or the network bandwidth is acquired in the source code service handle; finally, the target video stream corresponding to the target service handle is acquired and pushed to the first terminal; thereby causing the target video stream to match the network bandwidth and the screen resolution of the first terminal, and solving the problem in related art that the pushed video stream cannot match the bandwidth and resolution of the terminal device. On the other hand, because the target video stream is matched according to the screen resolution and network bandwidth of the first terminal, delayed display due to bandwidth mismatch problems or lagging problems caused by mismatched screen resolutions can be avoided, thereby improving the user's viewing experience.

In an exemplary embodiment of this disclosure, acquiring the target video stream corresponding to the target service handle includes:
acquiring, if the target service handle matching the screen resolution and/or the network bandwidth is acquired in the source code service handle, the target video stream corresponding to the target service handle; and
acquiring, if the target service handle matching the screen resolution and/or the network bandwidth cannot be acquired in the source code service handle, a transcoded video stream by transcoding a source video stream corresponding to the to-be-played stream identifier, and using the transcoded video stream as the target video stream.

In an exemplary embodiment of this disclosure, the source code service handle is stored in form of key-value pairs; a key of the source code service handle is a main stream identifier of a source video stream; and a value of the source code service handle is an original resolution and/or an original bit rate of the source video stream.

In an exemplary embodiment of this disclosure, a value of the source code service handle further includes one or more transcoding service handles; a key of the transcoding service handle is a transcoding identifier of the source video stream, and a value of the transcoding service handle is a transcoding resolution and/or a transcoding bit rate of a transcoded video acquired through transcoding.

In an exemplary embodiment of this disclosure, acquiring the transcoded video stream by transcoding the source video stream corresponding to the to-be-played stream identifier includes:
acquiring a source GOP included in the source video stream corresponding to the to-be-played stream identifier, and acquiring a source key frame included in the source GOP;
acquiring an IDR frame in the source key frame, and acquiring a sequence parameter set and a picture parameter set included in the IDR frame by parsing the IDR frame; and
initializing a preset transcoding function based on the sequence parameter set and the picture parameter set, and acquiring the transcoded video stream by transcoding the source video stream based on the initialized transcoding function.

In an exemplary embodiment of this disclosure, acquiring the transcoded video stream by transcoding the source video stream based on the initialized transcoding function includes:
acquiring encapsulated format data by decapsulating the source video stream based on the initialized transcoding function, and acquiring compressed audio data and compressed video data by decapsulating the encapsulated format data;
acquiring original audio data and original video data by performing audio decoding and video decoding on the compressed audio data and the compressed video data, and acquiring transcoded audio data and transcoded video data by transcoding the original audio data and the original video data; and
acquiring the transcoded video stream by encapsulating the transcoded audio data and the transcoded video data.

In an exemplary embodiment of this disclosure, the video stream processing apparatus further includes:
a transcoding service handle generation module, which may be configured to generate a transcoding identifier corresponding to the transcoded video stream, and generate a to-be-added transcoding service handle of the transcoded video stream based on the transcoding identifier, a transcoding resolution and a transcoding bit rate of the transcoded audio data and the transcoded video data; and
a source code service handle update module, which may be configured to update the source code service handle of the source video stream using the to-be-added transcoding service handle.

In an exemplary embodiment of this disclosure, a transcoded key frame included in each transcoded GOP of the transcoded video stream with different transcoding resolutions and transcoding bit rates is same as a source keyframe included in the source code GOP.

In an exemplary embodiment of this disclosure, before acquiring the transcoded video stream by transcoding the source video stream corresponding to the to-be-played stream identifier, and pushing the transcoded video stream to the first terminal, the video stream processing method further includes:
reading the transcoded GOP or the source code GOP, and placing the transcoded GOP or the source code GOP into a preset cache channel; and
pushing, based on a placement order of the transcoded GOP or the source code GOP in the cache channel, the transcoded GOP or the source code GOP to the first terminal.

In an exemplary embodiment of this disclosure, reading the transcoded GOP or the source code GOP includes:
acquiring one or more transcoding resolutions, and/or one or more transcoding bit rates, and/or a source code resolution and a source code bit rate included in the source code service handle;
acquiring a first difference calculation result by calculating a difference between the network bandwidth and the source code bit rate and/or the transcoding bit rate, and acquiring a second difference calculation result by calculating a difference between the screen resolution and the source code resolution and/or the transcoding resolution; and
determining the target service handle based on the first difference calculation result and the second difference calculation result, and reading the transcoded GOP or the source code GOP corresponding to a target stream identifier included in the target service handle.

In an exemplary embodiment of this disclosure, the transcoded GOP or the source code GOP includes a current key frame, a first predicted frame obtained by performing prediction on the current key frame, and a second predicted frame obtained by performing prediction on the current key frame and the first predicted frame; and
the video stream processing apparatus further includes:
a current key frame calculation module, which may be configured to acquire the current key frame by performing calculation on the source video stream based on a preset image recognition model, where the image recognition model includes any one or more of a convolutional neural network model, a recurrent neural network model, and a deep neural network model.

In an exemplary embodiment of this disclosure, the video stream processing apparatus may further include:
a main stream identifier configuration module, which may be configured to receive a source video stream sent by a second terminal, and configuring a main stream identifier for the source video stream;
a source code service handle generation module, which may be configured to generate a source code service handle of the source video stream according to an original resolution and an original bit rate of the source video stream and the main stream identifier; and
a co-source stream dictionary building module, which may be configured to construct the preset co-source stream dictionary according to the source code service handle.

In an exemplary embodiment of this disclosure, the video stream processing apparatus further includes:
a heartbeat response message detection module, which may be configured to send a heartbeat detection message to the first terminal at intervals of a first preset duration, and detect whether the first terminal sends a heartbeat response message corresponding to the heartbeat detection message within a second preset duration;
a to-be-deleted transcoding service handle acquisition module, which may be configured to obtain, if the first terminal does not send the heartbeat response message within the preset duration, a to-be-deleted transcoding service handle of the first terminal corresponding to the unsent heartbeat response message;
a to-be-deleted transcoding service handle deletion module, which may be configured to determine a source code service handle corresponding to the to-be-deleted transcoding service handle based on a transcoding stream identifier included in the to-be-deleted transcoding service handle, and deleting the to-be-deleted transcoding service handle from the source code service handle.

The specific details of each module in the above video stream processing apparatus have been described in detail in the corresponding video stream processing method, which will not be repeated here.

It should be noted that although several modules or units of apparatus for action execution are mentioned in the above detailed description, this division is not mandatory. In fact, according to embodiments of this disclosure, the features and functions of two or more modules or units described above may be embodied in one module or unit. Conversely, the features and functions of one module or unit described above may be further divided into being embodied by multiple modules or units.

Furthermore, although various steps of the methods in this disclosure are depicted in the drawings in a specific order, this does not require or imply that the steps must be performed in that specific order, or that all of the illustrated steps must be performed to achieve the desired results. Additionally or alternatively, certain steps may be omitted, multiple steps may be combined into one step for execution, and/or one step may be decomposed into multiple steps for execution.

In an exemplary embodiment of this disclosure, an electronic device capable of implementing the above method is further provided.

Those skilled in the art will understand that various aspects of this disclosure may be implemented as systems, methods, or program products. Therefore, various aspects of this disclosure may be embodied in the following forms, including: a complete hardware implementation, a complete software implementation (including firmware, microcode, and the like), or an implementation combining hardware and software, which may be collectively referred to herein as “circuit”, “module” or “system”.

An electronic device 1400 according to these embodiments of this disclosure is described below with reference to FIG. 14. The electronic device 1400 shown in FIG. 14 is only an example and should not bring any limitations to the functions and usage scope of the embodiments of this disclosure.

As shown in FIG. 14, the electronic device 1400 is embodied in the form of a general computing device. The components of the electronic device 1400 may include, but are not limited to: the above-mentioned at least one processing unit 1410, the above-mentioned at least one storage unit 1420, a bus 1430 connecting different system components (including the storage unit 1420 and the processing unit 1410), and a display unit 1440.

Herein, the storage unit stores program code, which can be executed by the processing unit 1410, thereby causing the processing unit 1410 to perform steps of various exemplary methods according to this disclosure described in the exemplary methods of this specification. For example, the processing unit 1410 may be configured to perform steps as shown in FIG. 1 including: in step S110, receiving a video playback request sent by a first terminal, and acquiring a to-be-played stream identifier, a network bandwidth and a screen resolution of the first terminal by parsing the video playback request; in step S120, acquiring, in a preset co-source stream dictionary, a source code service handle matching the to-be-played stream identifier, and acquiring, in the source code service handle, a target service handle matching the screen resolution and/or the network bandwidth; and in step S130, acquiring a target video stream corresponding to the target service handle, and pushing the target video stream to the first terminal.

The storage unit 1420 may include readable medium in the form of volatile storage units, such as an RAM (random access memory) 14201 and/or a cache storage unit 14202, and may further include an ROM (read-only memory) 14203.

The storage unit 1420 may also include a program/utility 14204 having a set of (at least one) program module 14205 including, but not limited to, an operating system, one or more application programs, other program modules, and program data. Each of these examples, or some combination thereof, may include the implementation of a network environment.

The bus 1430 may include one or more of several types of bus structures, including a memory unit bus, or a local area bus of a variety of any bus structures such as memory unit controller, peripheral bus, graphics acceleration port, processing unit, or the like.

The electronic device 1400 may also communicate with one or more external devices 1500 (e.g., keyboard, pointing device, Bluetooth device, and the like), may also communicate with one or more devices that enable a user to interact with the electronic device 1400, and/or may communicate with any device (e.g., router, modem, and the like) that enables the electronic device 1400 to communicate with one or more other computing devices. This communication may occur through an input/output (I/O) interface 1450. Furthermore, the electronic device 1400 may also communicate with one or more networks (e.g., a local area network (LAN), a wide area network (WAN), and/or a public network, such as the Internet) through a network adapter 1460. As shown, the network adapter 1460 communicates with other modules of the electronic device 1400 via bus 1430. It should be understood that, although not shown in the drawings, other hardware and/or software modules may be used in conjunction with the electronic device 1400, including but not limited to: microcode, device drivers, redundant processing units, external disk drive arrays, RAID systems, tape drives, data backup storage system, and the like.

Through the above description of the embodiments, those skilled in the art can easily understand that the exemplary embodiments described here can be implemented by software, or can be implemented by software combined with necessary hardware. Therefore, the technical solution according to some embodiments of this disclosure can be embodied in the form of a software product, which can be stored in a non-volatile storage medium (which may be a CD-ROM, U disk, mobile hard disk, or the like) or on the network, including several instructions to cause a computing device (which may be a personal computer, a server, a terminal device, a network device, or the like) to execute the method according to some embodiments of this disclosure.

In an exemplary embodiment of this disclosure, a computer-readable storage medium is further provided, on which a program product capable of implementing the method described above in this specification is stored. In some possible implementations, various aspects of this disclosure can also be implemented in the form of a program product, which includes program code. When the program product is run on a terminal device, the program code is used for causing the terminal device to perform the steps according to various exemplary embodiments of this disclosure described in the above exemplary methods of this specification.

The program product for implementing the above method according to some embodiments of this disclosure may adopt a portable compact disk read-only memory (CD-ROM) and include program code, and may be run on a terminal device, such as a personal computer. However, the program product of this disclosure is not limited thereto. In this document, a readable storage medium may be any tangible medium containing or storing a program that may be used by or in conjunction with an instruction execution system, apparatus, or device.

The program product may take the form of any combination of one or more readable medium. The readable medium may be a readable signal medium or a readable storage medium. The readable storage medium may be, for example, but not limited to, an electrical, magnetic, optical, electromagnetic, infrared, or semiconductor system, apparatus or device, or any combination thereof. More specific examples of readable storage medium include, but are not limited to, electrical connection with one or more wires, portable disk, hard disk, RAM, ROM, erasable programmable ROM (EPROM), flash memory, optical fiber, portable CD-ROM, optical storage device, magnetic storage device, or any suitable combination of the above.

A computer-readable signal medium may include a data signal propagated in baseband or as part of a carrier wave carrying readable program code therein. Such propagated data signals may take many forms, including but not limited to electromagnetic signals, optical signals, or any suitable combination thereof. A readable signal medium may also be any readable medium other than a readable storage medium that can send, propagate, or transport the program for use by or in connection with an instruction execution system, apparatus, or device.

Program code embodied on a readable medium may be transmitted using any suitable medium, including but not limited to wireless, wireline, optical cable, RF, or the like or any suitable combination thereof.

Program code for performing operations of this disclosure may be written in any combination of one or more programming languages, including object-oriented programming languages such as Java, C++, or the like, as well as conventional procedural programming language such as C or a similar programming language. The program code may be executed entirely on a user's computing device, partly on a user's device, as a stand-alone software package, partly on a user's computing device and partly on a remote computing device, or entirely on a remote computing device or a server. In situations involving the remote computing device, the remote computing device may be connected to the user computing device through any kind of network, including LAN or WAN, or may be connected to an external computing device (for example, through the Internet by using an Internet service provider).

In addition, the above-mentioned drawings are only schematic illustrations of processes included in the methods according to some exemplary embodiments of this disclosure, and are not intended to limit this disclosure. It is readily understood that the processes shown in the above drawings do not indicate or limit the temporal sequence of these processes. In addition, it is also easy to understand that these processes may be executed synchronously or asynchronously in multiple modules, for example.

Other embodiments of this disclosure will be readily apparent to those skilled in the art from consideration of the specification and practice of the invention disclosed herein. This application is intended to cover any modification, use or adaptation of this disclosure, and these modifications, uses or adaptations follow the general principles of this disclosure and include common knowledge or conventional technical means in the technical field not disclosed in this disclosure. The specification and examples are to be considered exemplary only, with the true scope and spirit of the disclosure indicated by the appended claims.

1. A video stream processing method, comprising:
receiving a video playback request sent by a first terminal, and acquiring a to-be-played stream identifier, a network bandwidth and a screen resolution of the first terminal by parsing the video playback request;
acquiring, in a preset co-source stream dictionary, a source code service handle matching the to-be-played stream identifier, and acquiring, in the source code service handle, a target service handle matching the screen resolution or the network bandwidth; and
acquiring a target video stream corresponding to the target service handle, and pushing the target video stream to the first terminal.

2. The video stream processing method according to claim 1, wherein acquiring the target video stream corresponding to the target service handle comprises:
acquiring, in response to that the target service handle matching the screen resolution or the network bandwidth is acquired in the source code service handle, the target video stream corresponding to the target service handle; and
acquiring, in response to that the target service handle matching the screen resolution or the network bandwidth is not acquired in the source code service handle, a transcoded video stream by transcoding a source video stream corresponding to the to-be-played stream identifier, and using the transcoded video stream as the target video stream.

3. The video stream processing method according to claim 1, wherein the source code service handle is stored in form of key-value pairs;
a key of the source code service handle is a main stream identifier of a source video stream; and
a value of the source code service handle is an original resolution or an original bit rate of the source video stream.

4. The video stream processing method according to claim 1, wherein a value of the source code service handle further comprises one or more transcoding service handles;
a key of the transcoding service handle is a transcoding identifier of the source video stream, and a value of the transcoding service handle is a transcoding resolution or a transcoding bit rate of a transcoded video acquired through transcoding.

5. The video stream processing method according to claim 2, wherein acquiring the transcoded video stream by transcoding the source video stream corresponding to the to-be-played stream identifier comprises:
acquiring a source picture group comprised in the source video stream corresponding to the to-be-played stream identifier, and acquiring a source key frame comprised in the source picture group;
acquiring an instantaneous decoding refresh (IDR) frame in the source key frame, and acquiring a sequence parameter set and a picture parameter set comprised in the IDR frame by parsing the IDR frame; and
initializing a preset transcoding function based on the sequence parameter set and the picture parameter set, and acquiring the transcoded video stream by transcoding the source video stream based on the initialized transcoding function.

6. The video stream processing method according to claim 5, wherein acquiring the transcoded video stream by transcoding the source video stream based on the initialized transcoding function comprises:
acquiring encapsulated format data by decapsulating the source video stream based on the initialized transcoding function, and acquiring compressed audio data and compressed video data by decapsulating the encapsulated format data;
acquiring original audio data and original video data by performing audio decoding and video decoding on the compressed audio data and the compressed video data, and acquiring transcoded audio data and transcoded video data by transcoding the original audio data and the original video data; and
acquiring the transcoded video stream by encapsulating the transcoded audio data and the transcoded video data.

7. The video stream processing method according to claim 6, further comprising:
generating a transcoding identifier corresponding to the transcoded video stream, and generating a to-be-added transcoding service handle of the transcoded video stream based on the transcoding identifier, a transcoding resolution and a transcoding bit rate of the transcoded audio data and the transcoded video data; and
updating the source code service handle of the source video stream using the to-be-added transcoding service handle.

8. The video stream processing method according to claim 5, wherein a transcoded keyframe comprised in each transcoded picture group of the transcoded video stream with different transcoding resolutions and transcoding bit rates is same as a source keyframe comprised in the source code picture group.

9. The video stream processing method according to claim 8, wherein, before acquiring the transcoded video stream by transcoding the source video stream corresponding to the to-be-played stream identifier, and pushing the transcoded video stream to the first terminal, the video stream processing method further comprises:
reading the transcoded picture group or the source code picture group, and placing the transcoded picture group or the source code picture group into a preset cache channel; and
pushing, based on a placement order of the transcoded picture group or the source code picture group in the cache channel, the transcoded picture group or the source code picture group to the first terminal.

10. The video stream processing method according to claim 9, wherein reading the transcoded picture group or the source code picture group comprises:
acquiring one or more transcoding resolutions, or one or more transcoding bit rates, or a source code resolution and a source code bit rate comprised in the source code service handle;
acquiring a first difference calculation result by calculating a difference between the network bandwidth and the source code bit rate or the transcoding bit rate, and acquiring a second difference calculation result by calculating a difference between the screen resolution and the source code resolution or the transcoding resolution; and
determining the target service handle based on the first difference calculation result and the second difference calculation result, and reading the transcoded picture group or the source code picture group corresponding to a target stream identifier comprised in the target service handle.

11. The video stream processing method according to claim 8, wherein the transcoded picture group or the source code picture group comprises a current key frame, a first predicted frame obtained by performing prediction on the current key frame, and a second predicted frame obtained by performing prediction on the current key frame and the first predicted frame; and
wherein the video stream processing method further comprises:
acquiring the current key frame by performing calculation on the source video stream based on a preset image recognition model, wherein the image recognition model comprises any one or more of a convolutional neural network model, a recurrent neural network model, and a deep neural network model.

12. The video stream processing method according to claim 1, further comprising:
receiving a source video stream sent by a second terminal, and configuring a main stream identifier for the source video stream;
generating a source code service handle of the source video stream according to an original resolution and an original bit rate of the source video stream and the main stream identifier; and
constructing the preset co-source stream dictionary according to the source code service handle.

13. The video stream processing method according to claim 1, further comprising:
sending a heartbeat detection message to the first terminal at intervals of a first preset duration, and detecting whether the first terminal sends a heartbeat response message corresponding to the heartbeat detection message within a second preset duration;
obtaining, in response to that the first terminal does not send the heartbeat response message within the preset duration, a to-be-deleted transcoding service handle of the first terminal corresponding to the unsent heartbeat response message; and
determining a source code service handle corresponding to the to-be-deleted transcoding service handle based on a transcoding stream identifier comprised in the to-be-deleted transcoding service handle, and deleting the to-be-deleted transcoding service handle from the source code service handle.

14-15. (canceled)

16. An electronic device, comprising:
a processor; and
a memory, configured to store executable instructions of the processor;
wherein the processor is configured to, through executing the executable instructions, implement a video stream processing method comprising:
receiving a video playback request sent by a first terminal. and acquiring a to-be-played stream identifier, a network bandwidth and a screen resolution of the first terminal by parsing the video playback request;
acquiring, in a preset co-source stream dictionary, a source code service handle matching the to-be-played stream identifier, and acquiring, in the source code service handle, a target service handle matching the screen resolution or the network bandwidth; and
acquiring a target video stream corresponding to the target service handle, and pushing the target video stream to the first terminal.

17. The electronic device according to claim 16, wherein acquiring the target video stream corresponding to the target service handle comprises:
acquiring, in response to that the target service handle matching the screen resolution or the network bandwidth is acquired in the source code service handle, the target video stream corresponding to the target service handle; and
acquiring, in response to that the target service handle matching the screen resolution or the network bandwidth is not acquired in the source code service handle, a transcoded video stream by transcoding a source video stream corresponding to the to-be-played stream identifier, and using the transcoded video stream as the target video stream.

18. The electronic device according to claim 16, wherein the source code service handle is stored in form of key-value pairs;
a key of the source code service handle is a main stream identifier of a source video stream; and
a value of the source code service handle is an original resolution or an original bit rate of the source video stream.

19. The electronic device according to claim 16, wherein a value of the source code service handle further comprises one or more transcoding service handles;
a key of the transcoding service handle is a transcoding identifier of the source video stream, and a value of the transcoding service handle is a transcoding resolution or a transcoding bit rate of a transcoded video acquired through transcoding.

20. The electronic device according to claim 17, wherein acquiring the transcoded video stream by transcoding the source video stream corresponding to the to-be-played stream identifier comprises:
acquiring a source picture group comprised in the source video stream corresponding to the to-be-played stream identifier, and acquiring a source key frame comprised in the source picture group;
acquiring an instantaneous decoding refresh (IDR) frame in the source key frame, and acquiring a sequence parameter set and a picture parameter set comprised in the IDR frame by parsing the IDR frame; and
initializing a preset transcoding function based on the sequence parameter set and the picture parameter set, and acquiring the transcoded video stream by transcoding the source video stream based on the initialized transcoding function.

21. The electronic device according to claim 20, wherein acquiring the transcoded video stream by transcoding the source video stream based on the initialized transcoding function comprises:
acquiring encapsulated format data by decapsulating the source video stream based on the initialized transcoding function, and acquiring compressed audio data and compressed video data by decapsulating the encapsulated format data;
acquiring original audio data and original video data by performing audio decoding and video decoding on the compressed audio data and the compressed video data, and acquiring transcoded audio data and transcoded video data by transcoding the original audio data and the original video data; and
acquiring the transcoded video stream by encapsulating the transcoded audio data and the transcoded video data.

22. A computer-readable storage medium storing a computer program thereon, wherein the computer program is used for, upon being executed by a processor, implementing a video stream processing method comprising:
receiving a video playback request sent by a first terminal, and acquiring a to-be-played stream identifier, a network bandwidth and a screen resolution of the first terminal by parsing the video playback request;
acquiring, in a preset co-source stream dictionary, a source code service handle matching the to-be-played stream identifier, and acquiring, in the source code service handle, a target service handle matching the screen resolution or the network bandwidth; and
acquiring a target video stream corresponding to the target service handle, and pushing the target video stream to the first terminal.
